(19) United States
(12) Patent Application Publication
(10) Pub. No.: US 2025/0277286 A1
(43) Pub. Date: Sep. 4, 2025

(54) SHELF DETECTION AND CONTROL FOR VACUUM ARC REMELTING

(71) Applicant: Titanium Metals Corporation, Henderson, NV (US)

(72) Inventors: Ashish D. PATEL, Wyomissing, PA (US); Nir HERSCOVICI, Las Vegas, NV (US); John J. DEBARBADILLO, Barboursville, WV (US); Corey O’CONNELL, Chesapeake, OH (US)

(73) Assignee: Titanium Metals Corporation, Henderson, NV (US)

(21) Appl. No.: 19/068,227

(22) Filed: Mar. 3, 2025

Related U.S. Application Data
(60) Provisional application No. 63/560,524, filed on Mar. 1, 2024.

(51) Int. Cl. C22B 9/20; C22B 9/04; G01B 11/06; G06T 7/13; G06T 7/60; G06V 10/25; G06V 10/44; G06V 10/82

(52) U.S. Cl. CPC C22B 9/20; C22B 9/04; G01B 11/06; G06T 7/13; G06T 7/60; G06V 10/25; G06V 10/44; G06V 10/82; G06T 2207/20081; G06T 2207/20084; G06T 2207/30136; G06V 2201/06

(57) ABSTRACT

A vacuum arc remelting (VAR) system for forming an ingot from an electrode includes a crucible configured to accommodate the electrode and the ingot, one or more electromagnetic energy sources arranged about the crucible, and a controller configured to provide electric current to the one or more electromagnetic energy sources and adjust the electric current through the one or more electromagnetic energy source. The adjustment of the electric current is based on an approximation of a thickness of a shelf, wherein the shelf is formed based on an accumulation of debris on an inner periphery of the crucible.

### CROSS-REFERENCE TO RELATED APPLICATIONS

This application claims priority to and the benefit of U.S. Provisional Patent Application No. 63/560,524, filed on Mar. 1, 2024. The disclosure of the above application is incorporated herein by reference.

### FIELD

The present disclosure relates to furnaces, and more specifically to anomaly reduction for vacuum arc furnaces.

### BACKGROUND

The statements in this section merely provide background information related to the present disclosure and may not constitute prior art.

A vacuum arc remelting (VAR) process is generally used in the processing of high-performance titanium, zirconium, nickel-based alloys and steel, among other alloys. Generally, a VAR system gradually melts an electrode by an electric current that flows through the electrode and arcs to molten metal contained within a crucible. The applied melting current is varied during the process, to achieve the desired molten metal pool geometry. At times, the electric arc can cause beads of metal to spatter onto portions of the crucible wall that are above the molten metal. These portions of the crucible are cold and can solidify the beads into a porous nonhomogeneous mass, which can cause irregularities in the ingot.

These issues related to VAR ingot surface quality and internal quality, among other issues related to VAR processes, are addressed by the present disclosure.

### SUMMARY

This section provides a general summary of the disclosure and is not a comprehensive disclosure of its full scope or all of its features.

An image is used to provide an indication of the quantity of spatter that has accumulated on the crucible wall. As the quantity of beads increases, as shown in the image, an electromagnetic energy source is implemented to reduce additional accumulation by adjusting the arc region used to melt the beads. For example, the magnetic fields emitted from the electromagnetic energy source may be increased based on the accumulated spatter to redirect the arc towards the surface of the ingot.

The spatter may be quantified using edge detection. Edges may be detected that indicate the spatter, the crucible, and the electrode within a portion of an image. The distances between the edges may be used to quantify the accumulation of beads on the crucible wall.

In one form of the present disclosure, a method for forming an ingot from an electrode with a system, the system including a crucible and one or more electromagnetic energy source, the method includes: melting a first portion of the electrode to form a molten pool within the crucible, wherein debris from the first portion of the electrode accumulate on an inner periphery of the crucible and the accumulation of the debris forms a shelf; approximating a thickness of the shelf; and operating the system, wherein the operation of the system is based on the approximation of the thickness of the shelf to control the shelf thickness during the melting.

In variations of this method, which may be implemented individually or in combination: the operation of the system includes melting the electrode based on the approximation of the thickness of the shelf; the operation of the system includes adjusting a gap between the electrode and the molten pool, wherein the adjustment of the gap is based on the thickness of the shelf; the gap is based on a weight of the ingot and a vertical position of the electrode; the operation of the system includes adjusting electric current through the one or more electromagnetic energy source, the adjustment of the electric current is based on the approximation of the thickness; the adjustment of electric current increases a root sum of squares value of the electric current over time; the approximation of the thickness is based on steps including: selecting a region of interest, wherein the region of interest is based on an image and the region of interest includes a depiction of an annular region between the electrode and the crucible; identifying first data based on the region of interest, wherein the first data is indicative of a first edge; identifying second data based on the region of interest, wherein the second data is indictive of a second edge; and determining a distance based on the first data and the second data; the distance is indicative of the thickness of the shelf as a percentage of the annular region between the electrode and the crucible occupied by the shelf; the region of interest includes pixel data and wherein the distance is based on a quantity of one or more pixels between a first pixel of the first data and a second pixel of the second data; the distance is based on a column of pixels or a row of pixels; the distance is a radial distance; the region of interest includes pixel data and wherein the identification of the first data is based on steps including removing hue information from the pixel data; the region of interest includes pixel data and wherein the identification of the first data is based on steps including applying a filter to the pixel data; the application of the filter removes noise between pixels of the pixel data, the application of the filter determines a gradient associated with the pixel data, or the application of the filter converts a pixel of the pixel data to a maximum value or a minimum value; the application of the filter is part of a thresholding algorithm; the application of the filter is part of an edge detection algorithm; the first edge is defined by an outer periphery of the electrode or the inner periphery of the crucible; the second edge is defined by one or more of the debris; the first data includes a first pixel within the region of interest and the second data includes a second pixel within the region of interest, and wherein the distance is based on a quantity of pixels between the first pixel and the second pixel; one or more portion of the first edge is continuous or one or more portion of the second edge is continuous; one or more portion of the first edge is discontinuous or one or more portion of the second edge is discontinuous; the selection of the region of interest is based on a neural network, and the neural network includes weights trained to recognize the region of interest based on a corpus of training images; the corpus of training images includes depictions of annular regions similar to the annular region; the depiction of the annular region between the electrode and the crucible includes a maximum distance between the electrode and the crucible within the image; and the system includes a camera and the method further includes: capturing the image with the camera; and sending the image to a network video recorder.

In another form of the present disclosure, a method for training a neural network to select a region of interest, wherein the region of interest includes a depiction of an annular region between an electrode and a crucible, the method includes: determining a corpus of training images, wherein the training images include predetermined bounding boxes and wherein the region of interest is similar to portions of the images encompassed by the predetermined bounding boxes; revising weights of the neural network, wherein the revision of the weights is based on a first subset of the corpus of training images and the revision of the weights is expected to reduce an error between the selection of the region of interest and the predetermined bounding boxes; and validating the neural network, wherein the validation of the neural network is based on a second subset of the corpus of training images.

In variations of this method, which may be implemented individually or in combination: the neural network includes one or more convolutional layer; the revision of the weights of the neural network is repeated until the validation of the neural network exceeds a predetermined value of loss; the neural network outputs a tensor including a location and a size of the region of interest; and the region of interest includes pixel data.

In another form of the present disclosure, a vacuum arc remelting (VAR) system for forming an ingot from an electrode, the system includes: a crucible configured to accommodate the electrode and the ingot; one or more electromagnetic energy sources arranged about the crucible; and a controller configured to: provide electric current to the one or more electromagnetic energy sources, and adjust the electric current through the one or more electromagnetic energy source, wherein the adjustment of the electric current is based on an approximation of a thickness of a shelf, wherein the shelf is formed based on an accumulation of debris on an inner periphery of the crucible.

In variations of this system, which may be implemented individually or in combination: the controller includes: one or more processor; and one or more non-transitory computer-readable medium, wherein the one or more non-transitory computer-readable medium including instructions executable by the one or more processor cause the controller to: provide the electric current, and adjust the electric current through the one or more electromagnetic energy source; the one or more electromagnetic energy source is toroidal, and the system further includes an axial electromagnetic energy source wound about a longitudinal axis of the crucible; the one or more electromagnetic energy source includes a first electromagnetic energy source and a second electromagnetic energy source; and the one or more electromagnetic energy source and the crucible are configured to move relative to one another along a longitudinal axis of the crucible.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic view of a vacuum arc remelting furnace in accordance with the teachings of the present disclosure;

FIG. 2A is a perspective view of a support assembly constructed in accordance with the teachings of the present disclosure;

FIG. 2B is a side view of the support assembly of FIG. 2A, illustrating a crucible mounted therein;

FIG. 3A is a partial top view of a vacuum arc remelting furnace in accordance with the teachings of the present disclosure;

FIG. 3B is a partial top view of an electromagnetic energy source of a vacuum arc remelting furnace in accordance with the teachings of the present disclosure;

FIG. 4A is a schematic of a controller architecture in accordance with the teachings of the present disclosure;

FIG. 4B is a schematic of a primary controller in accordance with the teachings of the present disclosure;

FIG. 4C is a schematic of a secondary controller in accordance with the teachings of the present disclosure;

FIG. 5 is a graph illustrating the current in each of the primary electromagnetic energy source and the secondary electromagnetic energy source being in phase in accordance with the teachings of the present disclosure;

FIG. 6A is a side view of a crucible and debris in accordance with the teaching of the present disclosure;

FIG. 6B is a top view of the crucible and one or more camera in accordance with the teachings of the present disclosure;

FIG. 7A is a side view of an ingot and an accumulation of debris in accordance with the teachings of the present disclosure;

FIG. 7B is a perspective view of an ingot and an accumulation of debris in accordance with the teachings of the present disclosure;

FIG. 8A depicts an image from one camera in accordance with the teachings of the present disclosure;

FIG. 8B depicts an image from one camera in accordance with the teachings of the present disclosure;

FIG. 8C depicts an image from one camera in accordance with the teachings of the present disclosure;

FIG. 8D depicts an image from one camera in accordance with the teachings of the present disclosure;

FIG. 9A depicts a region of interest in accordance with the teachings of the present disclosure;

FIG. 9B depicts a region of interest in accordance with the teachings of the present disclosure;

FIG. 9C depicts a region of interest in accordance with the teachings of the present disclosure;

FIG. 9D depicts a region of interest in accordance with the teachings of the present disclosure;

FIG. 10 depicts pixel data and individual pixels of a region of interest in accordance with the teachings of the present disclosure;

FIG. 11 depicts a portion of a region of interest in accordance with the teachings of the present disclosure;

FIG. 12A depicts a filter in accordance with the teachings of the present disclosure;

FIG. 12B depicts a filter in accordance with the teachings of the present disclosure;

FIG. 12C depicts a filter in accordance with the teachings of the present disclosure;

FIG. 13 is a diagram of a system in accordance with the teachings of the present disclosure;

FIG. 14 is a neural network in accordance with the teachings of the present disclosure;

FIG. 15 is a method in accordance with the teachings of the present disclosure; and

FIG. 16 is a subprocess in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

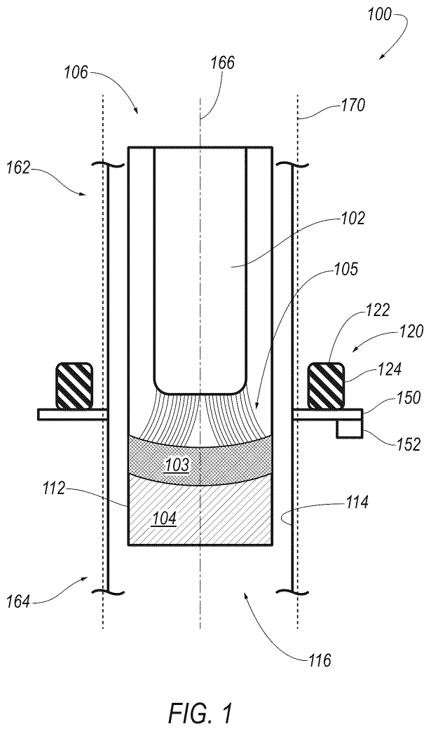

Referring to FIG. 1 a vacuum arc remelting (VAR) system 100 (also commonly referred to as a VAR furnace) is shown in accordance with one or more implementations of the present disclosure. The VAR system 100 is used to gradually melt an electrode 102 to form a pool of molten metal (e.g., molten pool 103) during the remelting process, which cools to form an ingot 104, described in greater detail below. The VAR system 100 includes a crucible assembly 106 that is configured to accommodate the electrode 102 and the ingot 104. As further shown, the crucible assembly includes an upper end portion 162 and a lower end portion 164.

The crucible assembly 106 accommodates the electrode 102 and holds the ingot 104 formed from the electrode 102. The crucible assembly 106 includes a crucible 112 and a cooling member 114 that defines a chamber 116 around the crucible 112 for receiving a coolant, such as water, to reduce the temperature of the crucible 112. Other suitable systems for cooling the crucible may also be used and are within the scope of the present disclosure.

During the remelting process, electrical arcs that function to melt the electrode 102 extend between the electrode 102 and the molten pool 103, or the ingot 104, generally defining an arc region 105 as shown. As described herein, the magnetic fields generated by an electromagnetic energy source are localized to this arc region 105 or the magnetic fields generated by an electromagnetic energy source are generated near the arc region 105, pushing the arc outwards towards the crucible 112 thereby resulting in improved surface quality of the ingot 104 and reducing the weight of electrode remnant at the end of the remelting process. Additional details regarding systems for localizing the electromagnetic energy source are illustrated and described in U.S. Pat. No. 11,434,544, which is commonly owned with the present application and the contents of which are incorporated herein by reference in their entirety.

For example, an electromagnetic energy source (e.g., electromagnetic energy source 120) is translated along a longitudinal axis 166 at a height/location associated with the arc region. The height may be based on a location of the ingot, which may be determined based on a weight of the ingot. In addition, a conventional axial winding 170 with respect to longitudinal axis 166 is disposed between the electromagnetic energy source 120 and the crucible assembly 106. This conventional axial winding 170 creates an electromagnetic field along the longitudinal axis 166 for stirring the molten pool 103 and for constricting the arc below the electrode 102. Or moving the arc away from the crucible.

The height of the electromagnetic energy source (e.g., electromagnetic energy source 120) with respect to a centroid of the electromagnetic energy source and the bottom of the crucible 112 may be the same or nearly the same as the height of the arcing surface of the electrode 102 (e.g., the bottom surface of the electrode 102) with respect to the bottom of the crucible 112. As the electrode 102 melts to form the ingot 104, the electromagnetic energy source 120 is translated along axis 166 to maintain a similar height. It should be appreciated that the speed of translation may be faster or slower than the change in height of the bottom of the electrode 102 with respect to the crucible 112. The electromagnetic energy source 120 may also be aligned with the gap between the electrode 102 and the ingot 104, the molten pool 103, the ingot 104, or somewhere there between and translate along the axis 166 as the electrode 102 melts. The electromagnetic energy source 120 is also aligned above the bottom melting surface of the electrode 102. The electromagnetic energy source 120 is shown situated on a carriage platform 150. The carriage platform 150 includes a sensor 152 (e.g., a distance sensor for measuring quantity of travel or position of the carriage platform 150 and electromagnetic energy source 120). The platform is part of a linear drive assembly configured to raise and lower the electromagnetic energy source along the longitudinal axis 166, which is described in greater detail below.

The electromagnetic energy source 120 may include windings 122. For example, wires are wound around a core 124 to form an electromagnet. The wires may be insulated to prevent cross conduction between windings. Additional sets of windings may be layered among winding 122 to form distinct current paths, allowing for an increased electromagnetic field energized from power sources (e.g., controllers, drivers) of predetermined capacities (e.g., maximum current rating). In one form, the electromagnetic energy source 120 has a toroidal or substantially toroidal shape. For example, cores (e.g., core 124) are toroidal or substantially toroidal and form one or more portions of a toroid. The windings (e.g., windings 122) of the electromagnetic energy source 120 may also be toroidal and form one or more portions of a toroid. These and other variations of electromagnetic energy should be construed as falling within the scope of the present disclosure.

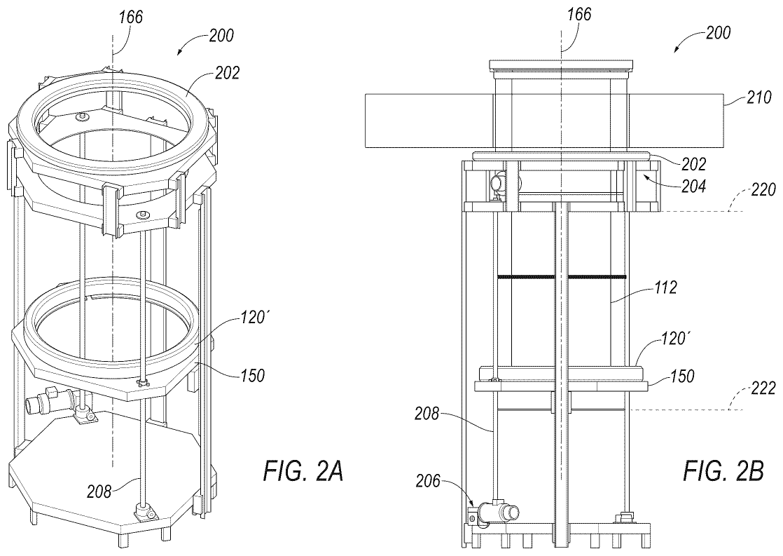

Referring to FIGS. 2A-2B, a support assembly 200 is shown in accordance with one or more implementations of the present disclosure. The support assembly 200 is constructed from a non-magnetic material (e.g., stainless steel) so as to not interfere with the generated electromagnetic fields described herein. The support assembly 200 is generally configured to orient the electromagnetic energy source 120 about the crucible 112. More specifically, the support assembly 200 is configured to mount and support both a primary electromagnetic energy source 120′ and a secondary electromagnetic energy source 202 about the crucible 112. Further, both the primary and secondary electromagnetic energy sources 120′, 202 are coaxial with the longitudinal axis 166 in this form of the present disclosure. The support assembly 200 further includes another platform (e.g., platform 204) to support the secondary electromagnetic energy source 202, which is fixed. Thus, the primary electromagnetic energy source 120′ and the crucible assembly 106 are configured to move relative to one another along the longitudinal axis 166, while the secondary electromagnetic energy source 202 is stationary and fixed to the upper end portion 162 of the crucible assembly 106.

The support assembly 200 generally defines a maximum travel height 220 and a minimum travel height 222 for the primary electromagnetic energy source 120′. Thus, the secondary electromagnetic energy source 202 is generally situated beneath a barrier or floor 210. For example, the top of the crucible 112 is accessible from a walking platform or floor 210, which is generally made of concrete. The support assembly 200 is secured to the floor 210, supported by stanchions or otherwise. In this manner, the secondary electromagnetic energy source 202 is configured to provide additional electromagnetic energy to melt the electrode 102 in an area that was previously unreachable by the translating primary electromagnetic energy source 120′. The maximum travel height may be indicated by a sensor (e.g., sensor 152) which may be situated and oriented to indicate a limit of the travel by physical contact with one or more portions of the support assembly 200.

As further shown, the support assembly 200 may include one or more actuators (e.g., electric motor 206, screw drive 208, support channels) that forms an actuator assembly (e.g., a linear drive assembly). For example, the electric motor 206 drives one or more screw drives 208 configured to translate the primary electromagnetic energy source 120′. The linear drive assembly is part of a more general lift mechanism/system, which is controlled by the vacuum arc remelting (VAR) system 100 as set forth in greater detail below.

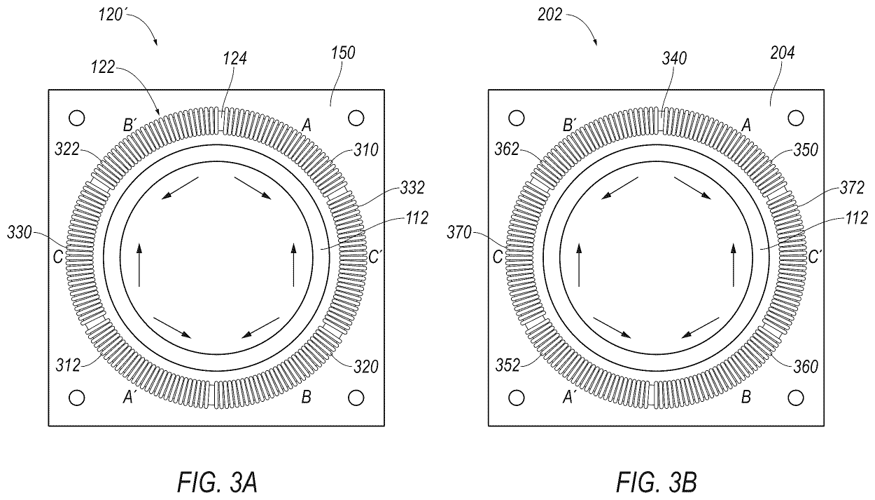

Referring to FIG. 3A, a partial top view of a VAR system 100 is shown in accordance with one or more implementations of the present disclosure. The system 100 includes one or more electromagnetic energy sources (e.g., primary electromagnetic energy source 120′). The primary electromagnetic energy source 120′ includes windings 122, which may be coils (e.g., coiled wire) wrapped around the core 124. The windings 122 are configured in segments (e.g., segments 310, 312, 320, 322, 330, 332). The segments are generally paired (e.g., coil pair A-A′; coil pair B-B′; and coil pair C-C′), where the coils of each pair are arranged on opposite sides of the core. For example, segment 310 is opposite segment 312 relative the crucible 112 to form a pair. Segment 320 is opposite segment 322 relative the crucible 112 to form another pair along with segment 330 being opposite segment 332 relative the crucible 112 to form another pair. Each segment 310, 312, 320, 322, 330, 332 is insulated or non-conductive with other segments 310, 312, 320, 322, 330, 332 and is energized with current having an opposite polarity from adjacent segments. Each coil pair is configured to receive a sinusoidal current, with the current in each pair being 120° out of phase. The direction of the magnetic field from each individual pair is represented by the arrows in FIGS. 3A-B. Once all three pairs are activated, the resultant magnetic field is rotational, with rotations per minute dictated by the time period of the sinusoidal current.

Referring to FIG. 3B, another partial top view of a VAR system 100 is shown in accordance with one or more implementations of the present disclosure, this time with the secondary electromagnetic energy source 202, which has a similar arrangement (e.g., second set) of segments. For example, as shown, the secondary electromagnetic energy source 202 includes a core 340 and segments 350, 352, 360, 362, 370, 372. The segments are paired (e.g., coil pair A-A′; coil pair B-B′; and coil pair C-C′), where the coils of each pair are arranged on opposite sides of the core). For example, segment 350 is opposite segment 352 relative the crucible 112 to form a pair. Segment 360 is opposite segment 362 relative the crucible 112 to form another pair along with segment 370 being opposite segment 372 relative the crucible 112 to form another pair.

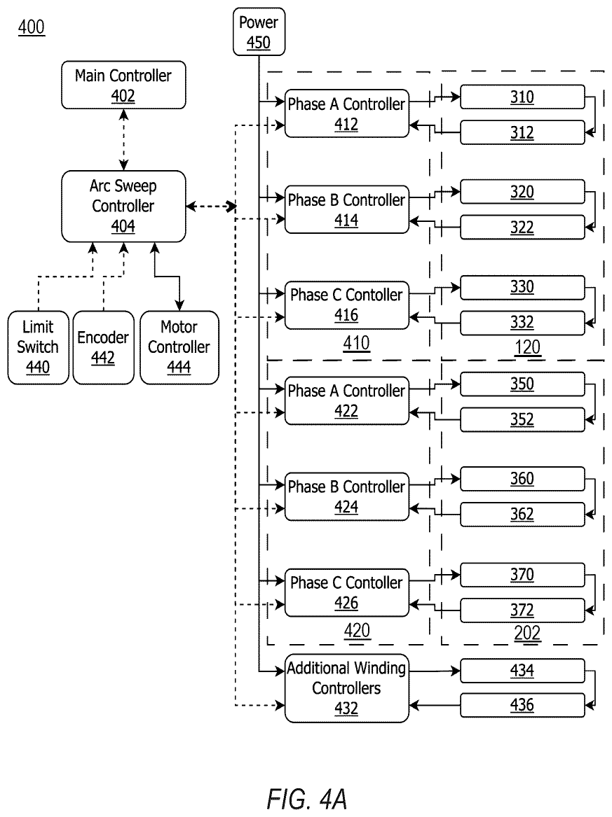

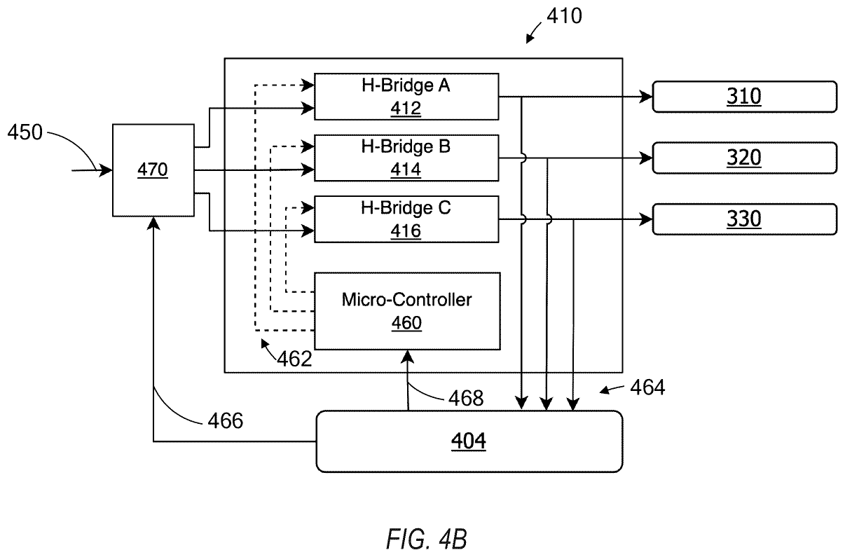

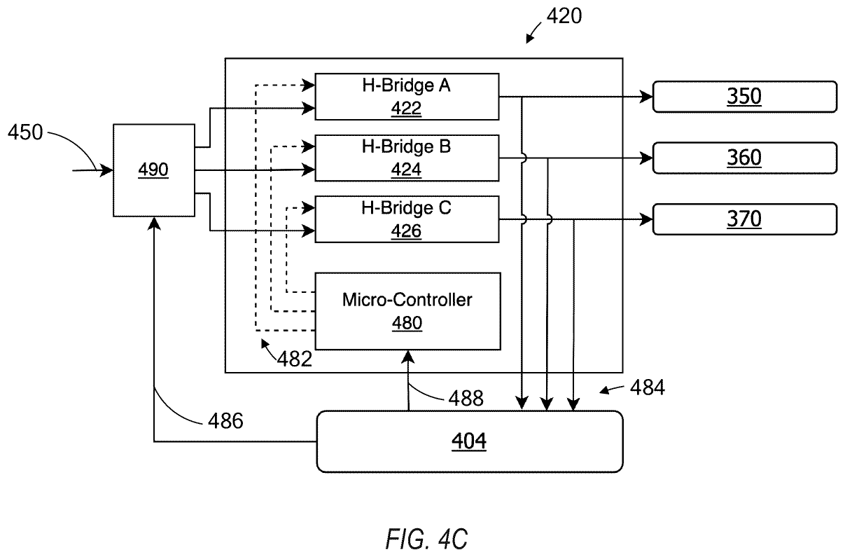

For example, and as shown with regard to FIG. 4A, in accordance with one or more implementations of the present disclosure, each of the primary electromagnetic energy source 120′ and secondary electromagnetic energy source 202 are powered by one or more controllers (e.g., primary controller 410, secondary controller 420) in a controller architecture 400. For example, primary electromagnetic energy source 120′ is powered by the primary controller 410 and the secondary electromagnetic energy source 202 is powered by the secondary controller 420. The primary controller 410 and the secondary controller 420 may include phase controllers (e.g., phase controllers 412, 414, 416, 422, 424, 426).

Although designated as distinct entities, the controllers (e.g., primary controller 410, secondary controller 420, phase controllers 412, 414, 416, 422, 424, 426) may be situated in one support assembly, board, card, or otherwise. All of the controllers described herein may be based on one or more processors. The controllers may be distributed. The controllers (e.g., phase controllers 412, 414, 416, 422, 424, 426) receive current (e.g., alternating current, direct current) from a power source 450. For direct currents, the controller (e.g., phase controllers 412, 414, 416, 422, 424, 426) may include an H-bridge for creating an alternating current from the received direct current.

A current (e.g., direct current) is received from the power source 450. For example, a first phase (e.g., phase A) is used to energize segments 310, 312, 350, 352. A second phase (e.g., phase B) is used to energize segments 320, 322, 360, 362. A third phase (e.g., phase C) is used to energize segments 330, 332, 370, 372. Further, additional windings may be used to increase the electromagnetic field generated by the primary and secondary electromagnetic energy sources 120′, 202. For example, the additional winding controller(s) 432 is used to incrementally increase the provided electromagnetic field with additional windings. The additional winding controllers 432 have the same form factor as controllers 412, 414, 416, 422, 424, 426, providing scalability for larger electromagnetic fields to be generated with the same hardware type.

For example, an additional winding controller 432 provides electric current for additional windings or segments 434, 436 which may be double wound in segment A-A′. For example, the primary electromagnetic energy source 120′ includes a second winding on one or more segments (e.g., segments 310, 312, 320, 322, 330, 332). That is, the additional winding controller 432 provides current to a second set of windings that are wrapped in combination with windings for segment 310 and segment 312. In such a way, additional current is used to generate larger magnetic fields by duplicating controller hardware using independent circuits.

The main controller 402 (e.g., a main VAR furnace controller) receives process parameters (e.g., a recipe) for remelting and provides status information to an HMI (Human Machine Interface). For example, the main controller 402 indicates (e.g., displays on the HMI) the position of the primary electromagnetic energy source 120 based on an indication of position from position sensor 442 (e.g., an encoder). The HMI may further depict the remelt location of the electrode 102, the current provided to one or more of electromagnetic energy source 120, 202, segment 310, 312, 320, 322, 330, 332, 350, 352, 360, 362, 370, 372, 434, 436, or a combination thereof. The main controller 402 directs the remelt process and notifies the arc sweep controller 404 that arc position control in the crucible 112 is desired. The main controller 402, the arc sweep controller 404, or combinations thereof are considered a master controller as they provide instructions to controllers that are downstream (e.g., receiving commands or inputs from upstream controllers). Communication between the main controller 402 and the arc sweep controller 404 may be provided through an Ethernet protocol. It should be understood, however, that other communications protocols, such as by way of example, transmission control protocol and internet protocol (TCP/IP), user datagram protocol (UDP), or controller area network (CAN) protocol may be employed while remaining within the scope of the present disclosure.

The arc sweep controller 404 provides the position of the primary electromagnetic energy source, the current provided to the primary and secondary electromagnetic energy sources 120′, 202, alarms, or combinations thereof. The arc sweep controller 404, or another controller, receives process inputs from one or more controller (e.g., main controller 402, primary controller 410, secondary controller 420). The arc sweep controller 404, or another controller, provides current settings to other controllers (e.g., the primary controller 410, the secondary controller 420), and those controllers control the output of the current allowed to flow between the power source 450 and the primary and secondary electromagnetic energy sources 120′, 202. The process inputs may include encoder position and current provided to the primary and secondary electromagnetic energy sources 120′, 202.

The arc sweep controller 404 receives an indication (e.g., an analog or digital input) provided by a limit switch (e.g., limit switch 440). More than one indication corresponding to multiple limit switches is contemplated. For example, each limit switch 440 may be configured to provide an indication when energy to the motor controller 444 should cease, ensuring that travel of the primary electromagnetic energy source 120′ is within a predetermined range. The limit switches 440 may be disposed on the support assembly 200 at the intended maximum height and minimum height of the primary electromagnetic energy source 120 or the intended maximum height (e.g., maximum travel height 220) and minimum height (e.g., minimum travel height 222) of the carriage platform 150 for the primary electromagnetic energy source 120′.

One or more position sensors (e.g., position sensor 442) are used to determine a position of the primary electromagnetic energy source 120′ as it moves longitudinally along the crucible 112 (e.g., longitudinal axis 166). The position sensors may be part of the electric motor 206. For example, the position sensors (e.g., position sensor 442) may measure an angular position in steps or otherwise of the output rotor of the electric motor. An additional sensor (e.g., sensor 152) may be attached to, or proximate, the carriage platform 150, which may be used alone or in combination with the other position sensors 442 to measure the position of the primary electromagnetic energy source 120′. Position sensors may also be used to measure the angular position of one or more screw drives 208. For example, the linear position of the screw drives 208 may be indictive of the movement of the primary electromagnetic energy source 120′ along the longitudinal axis 166 when considered in combination with the screw pitch or other information.

For example, the arc sweep controller 404 determines a numerical position (e.g., height) needed for the primary electromagnetic energy source 120′ to properly control the arc relative the bottom of the electrode 102. The arc sweep controller 404 then converts the numerical position into a quantity of steps to advance the electric motor 206 or screw drive 208 based on the position of the position sensor (e.g., position sensor 442) or until the position sensor reaches the desired destination. For example, the arc sweep controller 404 may be configured to track a position associated with the electrode 102 (e.g., bottom surface of the electrode 102) with a position of the primary electromagnetic energy source 120′ using a conversion between the position sensor 442 and a position associated with the electrode 102, continuously reducing a difference between the position of the primary electromagnetic energy source 120′ based on the position sensor and the position associated with electrode 102. The position associated with the electrode 102 may be the ingot height, which may be derived from the ingot weight.

The primary and secondary electromagnetic energy sources 120′, 202 may cause interference between their respective generated electromagnetic fields. For example, if the current or voltage associated with segment A of primary electromagnetic energy source 120′ (e.g., segment 310) is out of phase with the current or voltage associated with segment A of secondary electromagnetic energy source 202 (e.g., segment 350), the field associated with secondary electromagnetic energy source 202 may interfere, conflict, reduce, or otherwise impede the field associated with the primary electromagnetic energy source 120′.

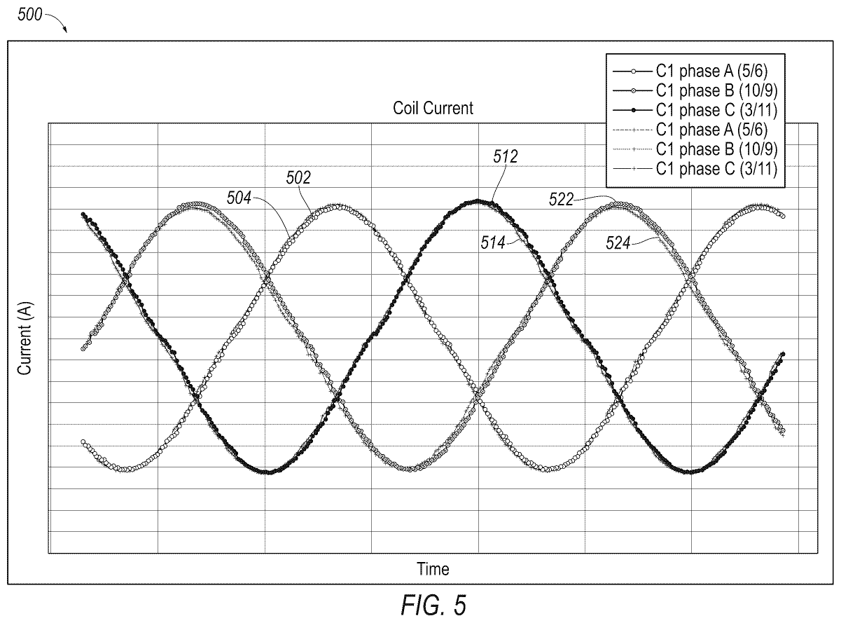

Referring to FIG. 4B, a controller is shown in accordance with one or more implementations of the present disclosure. It should be understood that the term “controller” is generally a depiction of the primary controller 410, the secondary controller 420 (FIG. 4C), or another controller indicated (e.g., additional winding controller 432 or phase controllers 412, 414, 416, 422, 424, 426). The primary controller 410 receives commands from the arc sweep controller 404. For example, the arc sweep controller 404 may provide an indication through an output (e.g., a digital or analog voltage output) to an input 468 associated with microcontroller 460. The microcontroller 460 receives that input as an indication to energize one or more of the phase controllers 412, 414, 416. A similar control signal may be sent to the secondary controller 420 for phase synchronization as discussed with regard to FIG. 5 for energization of phase controllers 422, 424, 426. Secondary controller 420 and phase controllers 422, 424, 426 have a similar construction to that shown with regard to primary controller 410 and phase controllers 412, 414, 416. Phase controllers 422, 424, 426 may receive a power, current, or voltage input from controller 470 or counterpart controller, or be operated by a counterpart controller similar to microcontroller 460 from instructions provided by arc sweep controller 404. Outputs from the phase controllers 422, 424, 426 are monitored and provided to the arc sweep controller 404 for control and operation of phase controllers 412, 414, 416, 422, 424, 426.

In this form, the microcontroller 460 is configured to operate the H-bridge of the phase controllers 412, 414, 416 based on control signal 462. For example, the microcontroller operates switches of the H-bridge, or half bridge(s), to generate an alternating current from a direct current provided from source 450. The switches may be pulse-width modulated (PWM) to form the sinusoidal alternating currents shown in FIG. 5. For example, the microcontroller 460 operates the switches for the H-bridge associated with phase controller 412 with a 120° offset from the switches for the H-bridge associated with phase controller 414 and 240° offset from the switches for the H-bridge associated with phase controller 416, providing three-phases as indicated in FIG. 5. The phase controllers 422, 424, 426 are similarly operated to provide current waveforms 502, 504, 512, 514, 522, 524.

The magnitude of each peak generated by the H-bridge phase controllers 412, 414, 416 are controlled by controller 470. The magnitude of each peak generated is controlled using controller 470 to balance peak currents of each phase and control the peak current output by the phase controllers 412, 414, 416, 422, 424, 426. For example, controller 470 receives an indication of desired power, current, voltage or combination thereof indication (e.g., indication 466). The indication 466 may be provided as a numeral value, a percentage of total power, or otherwise. For example, the controller 470 may receive a voltage within the range of 0-10 Volts, and the controller 470 may scale the output power, current, or voltage from 0-100% based on the indication (e.g., indication 466). The indication 466 is used to control the power, voltage, or current provided to respective H-bridges of phase controllers 412, 414, 416, 422, 424, 426. The indication 466 may be an analog voltage output from the arc sweep controller 404 to an analog input of controller 470 between 0.0-10 Volts and corresponding to and output of 0-400 Volts or 0-10 Amps of the controller 470. The indication 466 may also be between 0.0-5.5 Volts and corresponding to and output of 0-400 Volts or 0-10 Amps of the controller 470.

Taps 464 are provided to measure the power, voltage, current, or resistances of each of the coils or phases. For example, the arc sweep controller 404 may be configured to receive taps 464 as shown, providing an indication of the voltage, current, or power provided to segments 310, 312, 320, 322, 330, 332, 350, 352, 360, 362, 370, 372. Arc sweep controller 404 may be further configured to monitor a current loop based on segments 310, 312, 320, 322, 330, 332, 350, 352, 360, 362, 370, 372. For example, a current loop is formed between segments 310, 312 for measuring a resistance associated with those segments before remelting commences. The measured resistance may be used to ensure similar current, or voltage, peaks are formed and provided to the segments 310, 312, 320, 322, 330, 332 such that the resulting electromagnetic fields generated by the primary electromagnetic energy source 120 are balanced between segments.

For example, manufacturing and use may impart variations between segments 310, 312, 320, 322, 330, 332 and cause generated fields to have unequal magnitudes, which can result in reduced arc control or unbalanced arcing with respect to the longitudinal axis 166. As such, the resistances of current loops are measured by the arc sweep controller 404 and used to adjust power, current, or voltage output from controller 470 based on indication 466. The power, current, or voltage provided to segments 310, 312, 320, 322, 330, 332 may be based on the resistance of the current loop associated with one or more segments 310, 312, 320, 322, 330, 332.

Referring to FIG. 4C, a controller is shown in accordance with one or more implementations of the present disclosure. It should be understood that the term “controller” is generally a depiction of the primary controller 410, the secondary controller 420, or another controller indicated (e.g., additional winding controller 432 or phase controllers 412, 414, 416, 422, 424, 426). The secondary controller 420 receives commands from the arc sweep controller 404. For example, the arc sweep controller 404 may provide an indication through an output (e.g., a digital or analog voltage output) to an input 488 associated with microcontroller 480. The microcontroller 480 receives that input as an indication to energize one or more of the phase controllers 422, 424, 426.

In this form, the microcontroller 480 is configured to operate the H-bridge of the phase controllers 422, 424, 426 based on control signal 482. For example, the microcontroller operates switches of the H-bridge to generate an alternating current from a direct current provided from source 450. The switches may be pulse-width modulated (PWM) to form the sinusoidal alternating currents shown in FIG. 5. For example, the microcontroller 480 operates the switches for the H-bridge, or half bridge(s), associated with phase controller 422 with a 120° offset from the switches for the H-bridge associated with phase controller 424 and 240° offset from the switches for the H-bridge associated with phase controller 426, providing three-phases as indicated in FIG. 5.

The magnitude of each peak generated by the H-bridge phase controllers 422, 424, 426 are controlled by controller 490. The magnitude of each peak generated is controlled using controller 490 to balance peak currents of each phase and control the peak current output by the phase controllers 422, 424, 426. For example, controller 490 receives an indication of desired power, current, voltage or combination thereof indication (e.g., indication 486). The indication 486 may be provided as a numeral value, a percentage of total power, or otherwise. For example, the controller 490 may receive a voltage within the range of 0-10 Volts and the controller 490 may scale the output power, current, or voltage from 0-100% based on the indication (e.g., indication 486). The indication is used to control the power, voltage, or current provided to respective H-bridges of phase controllers 422, 424, 426. For example, secondary controller 420 may support voltages from zero to 400 Volts and currents from 0 to 10 Amps. The indication 486 may be an analog voltage output from the arc sweep controller 404 to an analog input of controller 490 between 0.0-10 Volts and corresponding to and output of 0-400 Volts or 0-10 Amps of the controller 490. The indication 486 may also be between 0.0-5.5 Volts and corresponding to and output of 0-400 Volts or 0-10 Amps of the controller 490.

Taps 484 are provided to measure the power, voltage, current, or resistances of each of the coils or phases. For example, the arc sweep controller 404 may be configured to receive taps 484 as shown, providing an indication of the voltage, current, or power provided to segments 310, 312, 320, 322, 330, 332, 350, 352, 360, 362, 370, 372. The arc sweep controller 404 may be further configured to monitor a current loop based on segments 310, 312, 320, 322, 330, 332, 350, 352, 360, 362, 370, 372. For example, a current loop (not shown) is formed between segments 350, 352 for measuring a resistance associated with those segments before remelting commences. The measured resistance may be used to ensure similar current, or voltage, peaks are formed and provided to the segments 350, 352, 360, 362, 370, 372 such that the resulting electromagnetic fields generated by the primary electromagnetic energy source 120′ are balanced between segments.

For example, manufacturing and use may impart variations between segments 350, 352, 360, 362, 370, 372 and cause generated fields to have unequal magnitudes, which can result in reduced arc control or unbalanced arcing with respect to the longitudinal axis 166. As such, the resistances of current loops are measured by the arc sweep controller 404 and used to adjust power, current, or voltage output from controller 490 based on indication 486. The power, current, or voltage provided to segments 350, 352, 360, 362, 370, 372 may be based on the resistance of the current loop associated with one or more segments 350, 352, 360, 362, 370, 372.

As shown in accordance with one or more implementations of the present disclosure, FIG. 5 illustrates the alignment of phases 500 for respective segments of the primary and secondary electromagnetic energy sources 120′ and 202. For example, segments 310, 312, 350, 352 have aligned phases and magnitude as shown with current waveforms 502, 504 that are shown in phase or substantially in phase (e.g., less than 30° out of phase). Segments 320, 322, 360, 362 have aligned phases as shown with current waveforms 512, 514 that are shown in phase or substantially in phase (e.g., less than 30° out of phase). Segments 330, 332, 370, 372 have aligned phases as shown with current waveforms 522, 524 that are shown in phase or substantially in phase (e.g., less than 30+θ out of phase).

As the primary electromagnetic energy source 120′ nears the maximum travel height (e.g., nears the location of one or more limit switches 440), the arc sweep controller 404 sends commands or otherwise causes the phase controllers (e.g., phase controllers 412, 414, 416) to increase current supplied to respective segments (e.g., segments 310, 312, 320, 322, 330, 332). Thus, the electrode 102 is continually remelted as the primary electromagnetic energy source 120′ reaches the maximum travel height 220, as indicated by limit switch 440 or position sensor 442. As the primary electromagnetic energy source 120′ reaches the maximum travel height 220, the current applied to the primary electromagnetic energy source 120′ (e.g., segments 310, 312, 320, 322, 330, 332) is increased. The increase may be exponential over ingot height (e.g., more exponential than linear) until the primary electromagnetic energy source 120′, or segments thereof, reach magnetic field saturation.

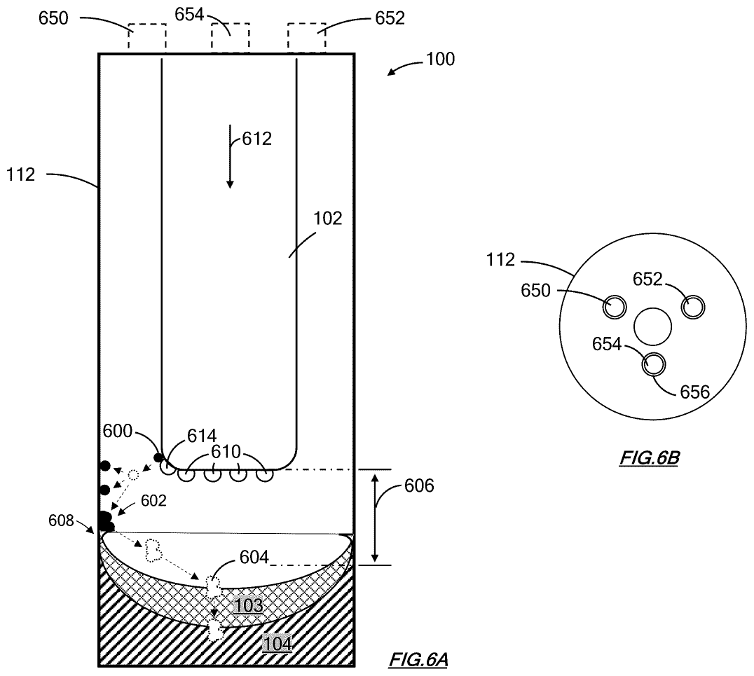

Referring to FIGS. 6A-6B, a crucible 112 is shown in accordance with the teaching of the present disclosure. As the electrode 102 is melted by the arc region 105, debris 600 splatter as beads and accumulate on the crucible 112. The debris 600 may cool quickly or faster than the solidification of the molten pool 103, accumulating, and forming a shelf 602 (e.g., crown, crest, ledge, protrusion, shoreline). The shelf 602, or portion thereof, may break off or detach from the crucible 112 as the ingot 104 and molten pool 103 rise during remelting, causing imperfections or irregularities 604 in the ingot (e.g., defects, white spots). The shelf 602 may be an accumulation of debris 600 that is detectable as an edge. The shelf 602 may be a detectable accumulation of debris 600 that requires remediation, mitigation, or reduction.

The debris 600 may include magnesium, calcium, chromium, manganese, and other evaporates, which may accumulate on a wall of the crucible 112 and coat solid particles. The debris 600 may include nitrides and oxides that wash onto the shelf 602. The shelf may overhang the molten pool 103 forming an undercut 608. The undercut 608 may cause a weakness in the attachment of the shelf 602 to the crucible 112 leading to eventual departure and formation of imperfections and irregularities 604. The molten pool 103 may be formed by pendant droplets 610 forming on the electrode 102 and falling into the molten pool 103. The electrode 102 may be translated in a direction 612 along the longitudinal axis 166 to form a gap 606 relative the bottom of the electrode 102 and the molten pool 103. The pendant droplets 610 may be irregular, and the gap 606 may be determined based on the stepper position of the motor controlling the position of the electrode 102 and the weight of the ingot 104. The pendant droplets 610 may form a torus 614. As described herein, the annular region 800 may be defined between the torus 614, the electrode 102, or a combination thereof.

A camera (e.g., camera 650, 652, 654) may be used to identify the shelf 602, or edge indicative thereof, within the annulus. For example, the camera may be positioned to view an annulus between the crucible 112 and the electrode 102. The cameras 650, 652, 654 may peer through a viewport (e.g., viewport 656) through the crucible assembly to view the annulus.

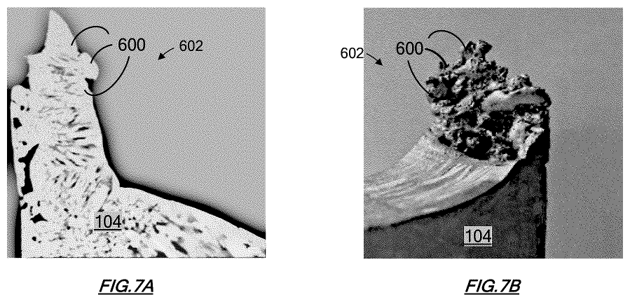

Referring to FIG. 7A, a side view of an ingot 104 and debris 600 is shown in accordance with the teachings of the present disclosure. The debris 600 may accumulate to form a shelf 602. The shelf 602, or portion thereof, may separate from the ingot 104 during the formation of the ingot 104 and fall into the molten pool 103.

Referring to FIG. 7B, a perspective view of an ingot 104 and debris 600 in accordance with the teachings of the present disclosure. The debris 600 may accumulate to form a shelf 602. The shelf 602, or portion thereof, may separate from the ingot 104 during the formation of the ingot 104 and fall into the molten pool 103.

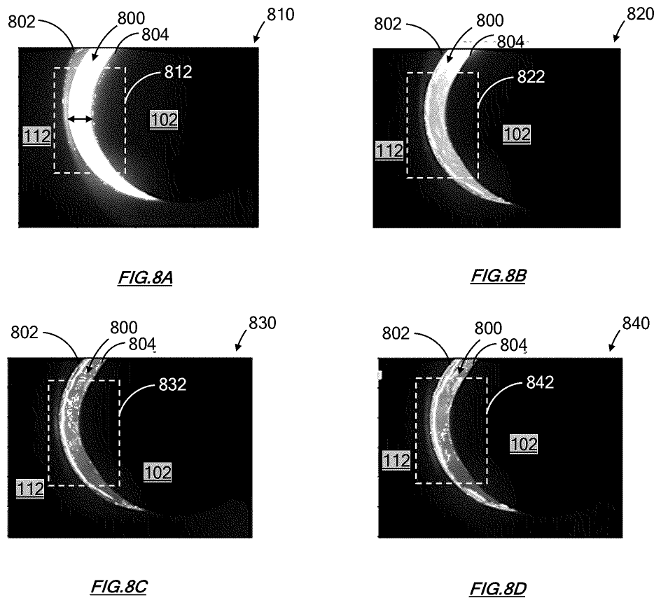

Referring to FIGS. 8A-8D, images 810, 820, 830, 840 are shown in accordance with the teachings of the present disclosure. The images 810, 820, 830, 840 may be captured by one or more camera (e.g., camera 650, 652, 654). One or more of the images 810, 820, 830, 840 may include data from more than one camera and the data maybe joined to form a composite image. The images 810, 820, 830, 840 may be two-dimensional and contain pixels. The images 810, 820, 830, 840 may be three-dimensional and contain voxels. The images 810, 820, 830, 840 may include data for each one of the pixels. The data may comprise a location of the pixel based on an index (e.g., row, column) and hue, luminance, color information in one or more formats (e.g., Red-Green-Blue, grayscale, Hue-Saturation-Lightness).

The images 810, 820, 830, 840 may be one or more frame of a motion picture or video. Frames from the video may be skipped. For example, the frames used for images 810, 820, 830, 840 may be scaled back from 30 frames per second to a range from one frame per second to four frames per second. The images 810, 820, 830, 840 depict the crucible 112, the electrode 102, and an annular region 800 between the electrode 102 and the crucible 112. The depiction of the crucible 112 forms an inner periphery 802 (i.e., inner diameter/surface of the crucible 112) within the image 810, indicating of a boundary between the depiction of the crucible 112 and the annular region 800. The depiction of the electrode 102 forms an outer periphery 804 (i.e., outer diameter/surface of the electrode 102) within the image 810, indicating a boundary between the depiction of the electrode 102 and the annular region 800.

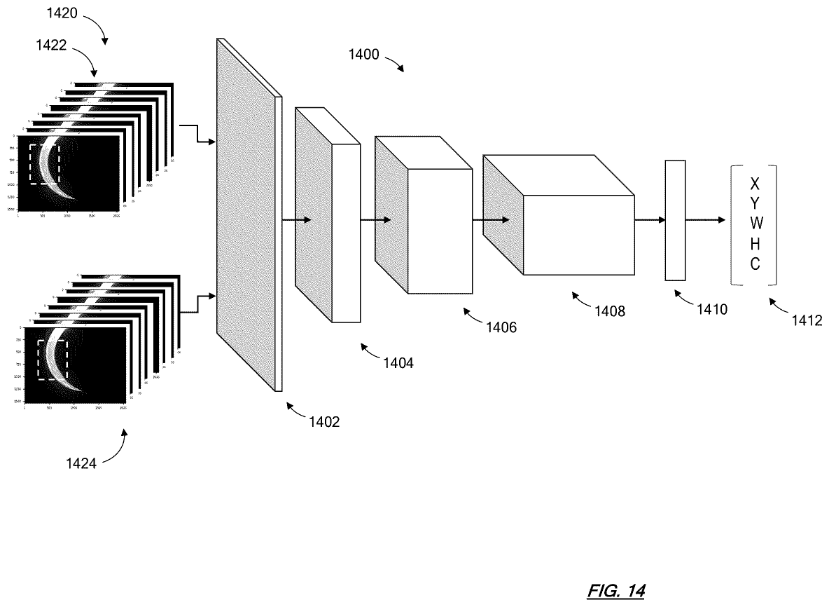

The images 810, 820, 830, 840 may individually or collectively depict changes to the debris 600, shelf 602, or annular region 800 at an instant or over time. In order to approximate a thickness of the shelf 602, a region of interest may be determined for the respective images (e.g., region of interest 812, 822, 832, 842). The region of interest 812, 822, 832, 842 may be determined based on machine learning. For example, the region of interest 812, 822, 832, 842 may be determined by a neural network, as shown in FIG. 14.

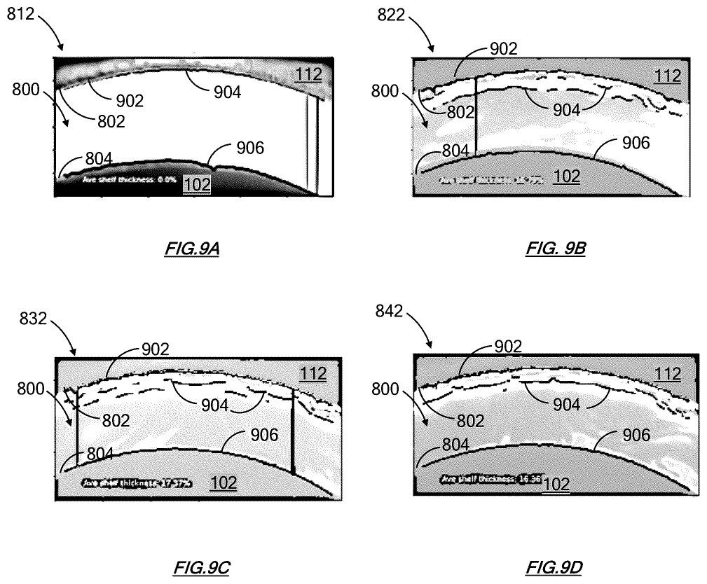

In FIGS. 9A-9D, (which are rotated clockwise 90 degrees relative to FIGS. 8A-8D), the regions of interest 812, 822, 832, 842 are shown in accordance with the teachings of the present disclosure. The regions of interest 812, 822, 832, 842 may be further processed to determine edges (e.g., edges 902, 904, 906) within the region of interest 812, 822, 832, 842. For example, an edge detection algorithm may be used to determine edge 902 based on the inner periphery 802 of the depiction of the crucible 112 and edge 906 based on the outer periphery 804 of the depiction of the electrode 102.

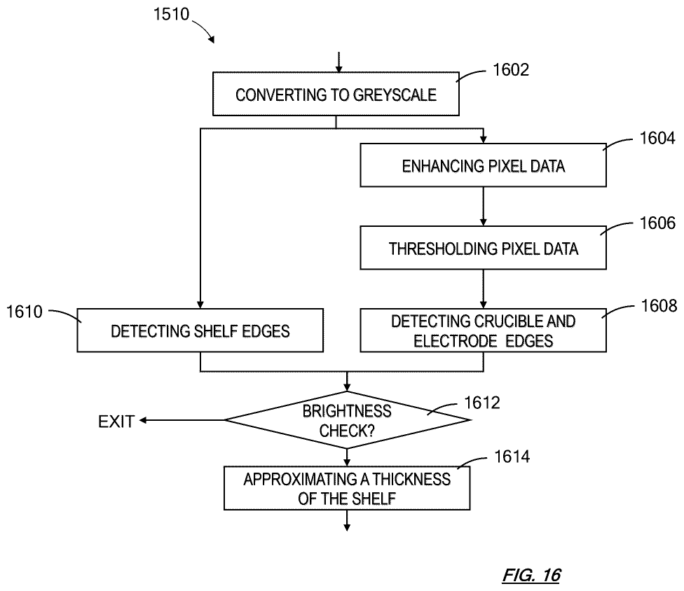

Edge 904 may be associated with the depiction of the shelf 602 within the annular region 800. For example, edge 904 within the annular region 800 between the outer periphery 804 of the depiction of the electrode 102 and the inner periphery 802 of the depiction of the crucible 112. The edges 902, 904, 906 may be continuous (e.g., adjacent pixels that form the edge from start to finish) or discontinuous. Edges 902, 904, 906 may be determined based on different version of the regions of interest 812, 822, 832, 842. For example, and with respect to region of interest 822, the edges 902, 904, 906 may be determined based on versions of the region of interest 822 after the application of different thresholding algorithms (e.g., Otsu) or sigma values (e.g., Gaussian filtering sigma values) discussed in further detail with regard to FIG. 16.

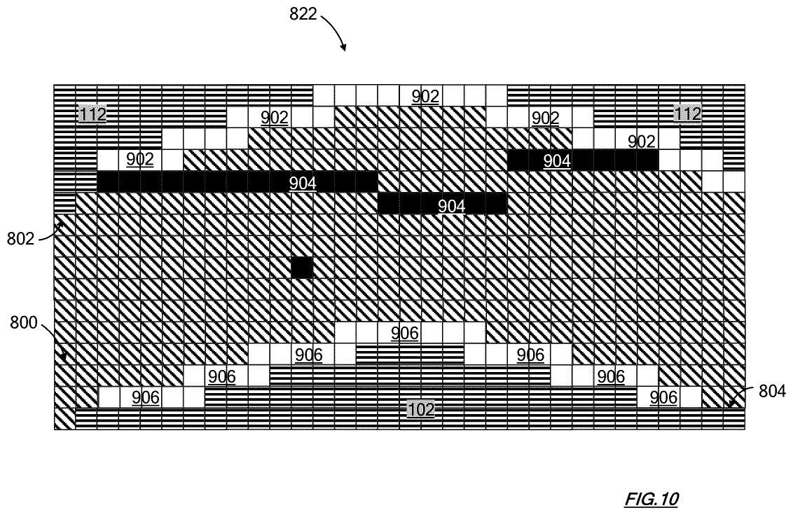

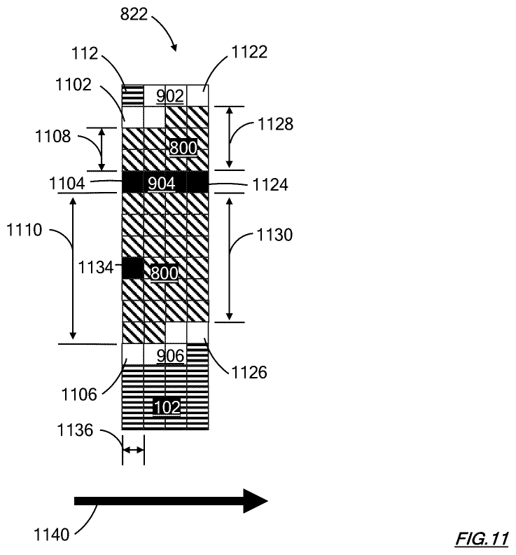

Referring to FIG. 10, individual pixels of the region of interest 822 in accordance with the teachings of the present disclosure. The pixels of the region of interest 822 are filled with respective patterns indicative of the categories associated with each of the pixels. For example, the pixels associated with the electrode 102 are patterned for designation, and pixels associated with the crucible 112 are patterned for designation. Pixels may be defined by one or more data structure (e.g., tuple, array) including location values (e.g., row, column), color information (e.g., RGB), and categorization (e.g., associated with the electrode 102, the crucible 112, an edge 902, 904, 906, or the annular region 800, periphery 802, 804, otherwise, or a combination thereof) to form data or pixel data.

Referring to FIG. 11, a portion of the region of interest 822 is shown in accordance with the teachings of the present disclosure. The portion of the region of interest 822 depicts the thickness of the shelf 602. For example, the edges 902, 904, 906 may be found using an edge detection algorithm with pixels (e.g., pixels 1102, 1104, 1106, 1122, 1124, 1126). Data indicative of the edges 902, 904, 906 may be stored in a data structure comprising pixel data that includes the location or index of the pixel (e.g., row, column) and a category of the pixel (e.g., no edge, edge 902, edge 904, edge 906). For example, a pixel may be defined in a data structure (e.g., PANDAS DATAFRAME) as [row index, column index, Red, Green, Blue, type] of the image 820 or region of interest 822 (e.g., [5, 10, 255, 255, 255, edge 902]).

Relative distances 1108, 1110, 1128, 1130 may be used to determine a thickness of the shelf 602. For example, the distance between each pixel of the edge 904 may be determined with respect to either the edge 902 associated with the crucible 112 or the edge 906 associated with the electrode 102.

The distance 1108 is determined with respect to pixel 1102 and pixel 1104 according to the vertical column of pixels. Distance 1108 may be inclusive of pixel 1102 and pixel 1104 (e.g., pixel distance of four) or exclusive (e.g., pixel distance of two). The distance 1110 is determined with respect to pixel 1104 and pixel 1106 according to the vertical column of pixels. Distance 1110 may be inclusive of pixel 1104 and pixel 1106 (e.g., pixel distance of nine) or exclusive (e.g., pixel distance of seven).

The distance 1128 is determined with respect to pixel 1122 and pixel 1124 according to the vertical column of pixels. The distance 1128 may be inclusive of pixel 1122 and pixel 1124 (e.g., pixel distance of five) or exclusive (e.g., pixel distance of three). The distance 1130 is determined with respect to pixel 1124 and pixel 1126 according to the vertical column of pixels. The distance 1130 may be inclusive of pixel 1124 and pixel 1126 (e.g., pixel distance of eight) or exclusive (e.g., pixel distance of six).

The average (e.g., mean, median, mode) of the pixel distances 1108, 1128 between the edge 904 and one of the other edges 902, 906 may be used to determine the overall percentage of the annular region 800 occupied by the shelf 602. For example, the mean distance between edge 904 and edge 902 is 4.5 pixels and the mean quantity of pixels forming the annular region (e.g., distance between edge 902 and edge 906) is twelve pixels, indicating that the shelf 602 occupies a percentage of 37.5% of the annular region 800 with regard to this portion of the region of interest 822 at the time that image 820 was taken. Although described with respect to vertical distances, horizontal distances or radial distances (e.g., based on the Pythagorean theorem) may be used. Maximum or minimum values of the pixel distances 1108, 1128 are contemplated as well.

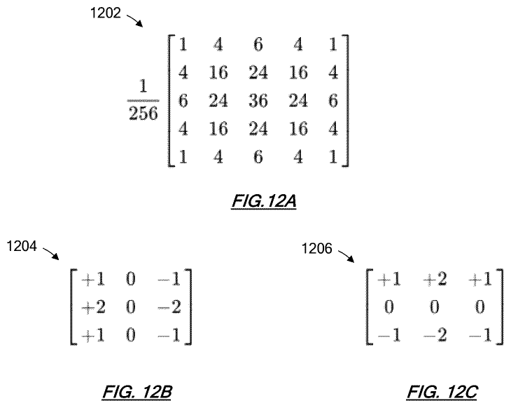

Referring to FIGS. 12A-12C, filters 1202, 1204, 1206 are shown in accordance with the teachings of this disclosure. Filter 1202 is an example Gaussian filter that may remove noise between pixels of pixel data. The Gaussian filter may be various dimensions (e.g., 5×5, 3×3). The Gaussian filter may be defined by one or more sigma values indicative of a strength of the filter. Filters 1204, 1206 are edge detection filters (e.g., Sobel operators) for detecting edges in a first direction with filter 1204 and a second direction with filter 1206. The filters 1204, 1206 may be used to determine a gradient with respect to an individual pixel for an orientation of the operator (e.g., horizontal for filter 1204, vertical for filter 1206).

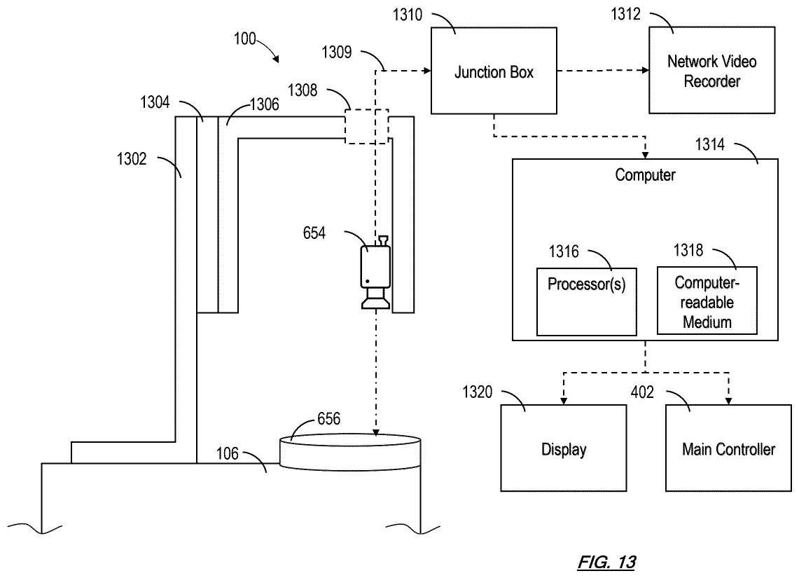

Referring to FIG. 13, another portion of system 100 is shown in accordance with the teachings of this disclosure. The system 100 further includes a mounting bracket 1302 for camera 654. Additional mounting brackets (not shown) are used to mount the other cameras (e.g., cameras 650, 652) from the crucible assembly 106. Electrical insulation 1304 is provided to isolate the camera 654 and other electronics from the arc region 105 and other currents in and around the crucible assembly 106. A faraday cage 1306 may also be used to prevent electromagnetic fields from reaching the camera 654 and the surrounding area. The camera 654 views the annular region 800, crucible 112, and electrode 102 through viewport 656. The camera 654 may include one or more outlet wires 1309 and interfaces (e.g., serial digital interface, HDMI) to transport images from the camera 654 to junction box 1310. The outlet wires 1309 may traverse a plug, gasket, or strain relief implement 1308. The junction box 1310 may duplicate or split the received video signal from the camera 654 or series of images to a network video recorder 1312. The network video recorder 1312 may store the series of images (e.g., images 810, 820, 830, 840) to form a corpus of training images (e.g., corpus of training images 1420 of FIG. 14). The corpus of training images may be curated to ensure that they depict the annular region 800, the crucible 112, and the electrode 102.

The images (e.g., images 810, 820, 830, 840) may also be sent to a computer 1314. The computer 1314 includes circuitry and one or more processor 1316 and one or more computer-readable medium 1318. The computer 1314 may be associated with a display 1320 and configured to provide an indication of the thickness of the shelf 602 to the main controller 402 or any other controller described herein. The computer-readable medium 1318 may include instructions that when executed by the one or more processor 1316 cause the processor 1316 to carry out one or more of the steps or actions described herein. For example, the execution may cause the processor 1316 to revise weights of a neural network 1400, validate the neural network 1400, select a region of interest 812, 822, 832, 842, approximate a thickness of the shelf 602, or any other step described herein.

Referring to FIG. 14, one form of an architecture for a neural network 1400 is shown in accordance with the teachings of this disclosure. The neural network 1400 may be implemented to determine the region of interest 812, 822, 832, 842, and the neural network 1400 may be trained on a corpus of training images 1420. The neural network 1400 includes a series layers (e.g., 1402, 1404, 1406, 1408, 1410). Each layer may include a combination of convolutional, pooling, and connected layers that are applied to images (e.g., image 810, 820, 830, 840) containing pixel data. The architecture for neural network 1400 may be based on a YOU ONLY LOOK ONCE architecture (e.g., YOLOv1, YOLOv5, YOLOR). A convolutional layer is a filter to detect features within an image by moving a kernel with respective weights (e.g., numerical values) in a matrix or tensor, across the resultant image for each layer (e.g., image 810, 820, 830, 840 for the first layer). The weights are multiplied with each input (e.g., pixels) to create a feature map. The convolutional layers become progressively smaller along the neural network 1400 (e.g., 1280×1280×3, 640×640×64, 320×320×128) to a fully connected layer (e.g., layer 1410). Each convolutional layer may have respective kernel sizes (e.g., 7×7), stride (e.g., two), padding, and other parameters.

The convolutional layer may be used to detect features (e.g., the size and shape of inner periphery 802, the size and shape of the outer periphery 804, the size and shape of the annular region 800) based on an image. The combination of these features over the course of the neural network 1400 results in the identification of the region of interest (e.g., region of interest 812, 822, 832, 842). In one form, an activation function or layer, such as a Rectified Linear Unit (ReLU), leaky ReLU, sigmoid, sigmoid linear unit (SiLU), or tanh, may follow the convolutional layer to increase the nonlinearity in the output of the convolutional layer. A pooling layer is often applied after a convolutional layer or activation layer to down-sample the feature map and summarize the features. Connected layers then apply a linear transformation to the input by applying the dot product between the weights and the input. The application of these layers (e.g., layers 1402, 1404, 1406, 1408, 1410) to produce a tensor 1412 corresponding to features of the region of interest 812, 822, 832, 842.

The neural network 1400 includes a first layer 1402. The first layer 1402 includes a convolutional layer that is applied to the image (e.g., image 810, 820, 830, 840). The convolutional layer of the first layer 1402 may include a 7×7 kernel that moves across the input (e.g., image 810, 820, 830, 840) and is multiplied with the data of the image to form a convolved output for input into second layer 1404 or another layer. Other kernel sizes may be used as well such as a 1×1, 2×2, 3×3, and so on. In one variation, an activation layer may be applied to the convolved feature map to increase the nonlinearity in the output of the convolutional layer. The first layer 1402 may also include a pooling layer to down-sample the feature map. In one form, a 2×2 max pooling layer is used, however other types (e.g., average pooling) or sizes (e.g., 3×3) may be used as well.

The neural network 1400 includes a second layer 1404 that includes another convolutional layer and pooling layer that would be applied to the output of the first layer 1402. In one form, the convolutional layer may include a 3×3 kernel, or other appropriate size. In one variation the convolutional layer may be followed by an activation layer. In one form, the pooling layer that follows the convolutional layer or activation layer may be a 2×2 max pooling layer, however other types or sizes of pooling layers may be used as well.

Following the second layer 1404, the neural network 1400 includes a third layer 1406. The third layer 1406 may include multiple convolutional layers with varying kernel sizes. In one form, the third layer 1406 may include a convolutional layer with a 1×1 kernel that is applied to the output of the second layer 1404. Following the 1×1 convolutional layer, the third layer 1406 may include another convolutional layer with a 3×3 kernel that is applied to the output of the 1×1 convolutional layer. In one form, the convolutional layers may be a series of alternating 1×1 and 3×3 convolutional layers applied successively. In one variation, the third layer 1406 may include additional convolutional layers of varying sizes and dimensions. In one variation, an activation layer, such as a ReLU or SiLU layer, may be applied after each 3×3, 1×1, or all convolutional layers to decrease the nonlinearity in the output of the convolutional layers. Other kernel sizes may be used as well such as a 2×2, 4×4, 5×5, and so on. The third layer 1406 also includes a pooling layer following the last convolutional layer.

The neural network 1400 includes a fourth layer 1408 that is applied to the output of the third layer 1406. The fourth layer 1408 may include multiple convolutional layers with varying kernel sizes. In one form, the fourth layer 1408 includes two convolutional layers with 3×3 kernels. In other forms, other kernel sizes may be used as well. In one variation, an activation layer may be applied after each convolutional layer. In some variations, a pooling layer may be applied after the convolutional layer.

After the fourth layer 1408, the neural network 1400 includes a fully-connected layer 1410. The fully-connected layer 1410 applies a linear transformation to the output of the fourth layer 1408 by applying the dot product between a tensor of weights and the output of the fourth layer 1408. The application of the layers 1402, 1404, 1406, 1408, 1410 produce a tensor 1412 with an x-coordinate and y-pixel coordinate (e.g., [300, 400]) indicative of the center of the region of interest (e.g., region of interest 812, 822, 832, 842), a width, a height, and a confidence score. In other forms, the tensor 1412 may include other dimensions corresponding to the desired geometry, such as a radius. Other architectures for determining the region of interest 812, 822, 832, 842 may be used as well, such as, but not limited to, those used in YOLO, R-CNN, Fast R-CNN, Faster R-CNN, RetinaNet, CenterNet, or another neural network trained for object detection using bounding boxes. Other architectures may be used to determine the region of interest 812, 822, 832, 842 based on the input images 810, 820, 830, 840.

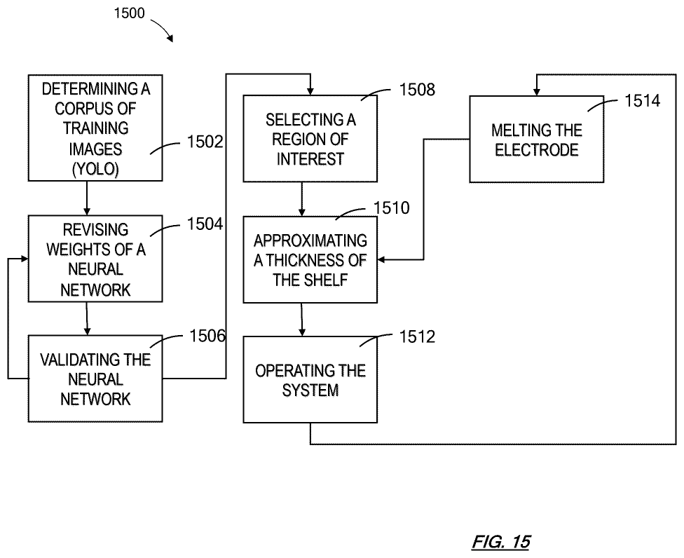

Referring to FIG. 15, a method 1500 is shown in accordance with one or more implementations of the present disclosure. Any of the steps depicted in method 1500 may be omitted, rearranged, or duplicated.

The method 1500 may include training a neural network 1400 to select a region of interest 812, 822, 832, 842 and adjusting the melting parameters (e.g., electric current, voltage, ram position, among others) to control the melting of the electrode 102 and the thickness of the shelf 602. The region of interest 812, 822, 832, 842 includes a depiction of the annular region 800 between the electrode 102 and the crucible 112. In one form, the region of interest 812, 822, 832, 842 includes a depiction of the annular region 800 that has the greatest distance between the electrode 102 and the crucible 112 within the respective image 810, 820, 830, 840. The region of interest 812, 822, 832, 842 may include a depiction of other areas of the annular region 800, so long as the selection of the region of interest 812, 822, 832, 842 is consistent between images.

In step 1502, a corpus of training images is determined. A corpus of training images 1420 is a collection of curated images used to train a neural network. The corpus of training images includes images similar to the images 810, 820, 830, 840 shown in FIGS. 8A-8D with an annular region 800 between the outer periphery 804 of electrode 102 and the inner periphery 802 the crucible 112. The images may be augmented to improve generalization by the neural network 1400. For example, the images may be reoriented, skewed, scaled, have color adjustments, or a combination thereof. Additionally, the corpus of training images includes predetermined bounding boxes (e.g., user-defined bounding boxes establishing a ground truth) that correspond to the desired region of interest 812, 822, 832, 842. In one form, the predetermined bounding boxes are rectangular with a width, height (e.g., 800 pixels by 1200 pixels), and center point having an x-coordinate and a y-coordinate (e.g., [300, 400]) that correspond to a predetermined coordinate system for the corpus of training images. In other variations, the bounding box may have other geometries such as, but not limited to, circular with a corresponding radius, oval, or other shapes that adequately capture the desired portion of the annular region 800. The predetermined region of interest may always include a depiction of the annular region 800 that has the greatest distance between the electrode 102 and the ingot 104 (e.g., the widest part of the crescent).

Similar to the predetermined bounding box, the region of interest 812, 822, 832, 842 may represent a bounding box determined based on a neural network. The recognized region of interest 812, 822, 832, 842 includes a center point with an x-coordinate and a y-coordinate (e.g., [300, 400]). The region of interest 812, 822, 832, 842 may have a similar geometry as the predetermined bounding box. In one form, the region of interest 812, 822, 832, 842 can be rectangular with a width and height dimension (e.g., 800 pixels by 1200 pixels). A comparison of the resulting region of interest from the neural network 1400 may be compared with the predetermined bounding box to determine a confidence score that corresponds to an intersection over union (IOU) between the region of interest determined by the neural network and the predetermined bounding box that establishes the ground truth. This error may be used to revise the weights of the neural network 1400 based on back propagation to minimize or reduce the error in the next training evolution.

The corpus of training images 1420 is divided into a first subset (e.g., subset 1422) and a second subset (e.g., subset 1424). The first subset (e.g., subset 1422) of the corpus of training images 1420 are used for revising the weights of the neural network, and the second subset (e.g., subset 1424) of the corpus of training images 1420 are used for validating the neural network 1400. The corpus of training images 1420 may be divided into smaller subsets to increase the number of times the neural network 1400 is trained or validated.

In step 1504, the first subset 1422 of the corpus of training images 1420 is used to train the neural network 1400 and adjust the weights to reduce the error between the selection of the region of interest 812, 822, 832, 842 and the predetermined bounding boxes. The weights may be adjusted by using backward propagation (e.g., stochastic gradient descent) based on the error between the predetermined bounding boxes and the predicted bounding box for the given image.

The first subset 1422 of the corpus of training images 1420, or portion thereof, is used to train the neural network 1400. The neural network 1400 can include a series of convolutional, pooling, and connected layers. The convolutional and connected layers have various matrices comprising weights that are applied to input data based on an image (e.g., image 810, 820, 830, 840) to produce an output. The matrices comprising weights may include a weight term to be multiplied with the input and a biasing term to be added to the resulting product. The weight term, biasing term, or both the weight and biasing term may be zero or within a range (e.g., −1 to 1). The matrices comprising weights of the convolutional layers and the connected layers may be adjusted based on the first subset 1422 of the corpus of training images 1420. The weights are adjusted to reduce the error between the selection of the region of interest 812, 822, 832, 842 and the predetermined bounding boxes.

In step 1506, the neural network 1400 is applied to the second subset 1424 of the corpus of training images 1420 to validate the neural network 1400. Validating the neural network 1400 with the second subset 1424 of training images evaluates the accuracy of the neural network 1400 in identifying selected region of interest 812, 822, 832, 842 in relation to the predetermined bounding boxes. The revision of the weights of the neural network 1400 in step 1504 is repeated until the validation of the neural network exceeds a predetermined value of loss. In one form, the loss is determined using sum-squared error. That is the loss is equal to the summation of the squared difference between the region of interest (e.g., region of interest 812, 822, 832, 842) and predetermined bounding boxes x-coordinates, y-coordinates, widths, and heights. Other loss functions such as, but not limited to, intersection over union loss, Euclidean distance, or mean squared error can be used to evaluate the neural network.

In step 1508, a region of interest 812, 822, 832, 842 is selected. The region of interest may be based on the trained and validated neural network 1400. Images (e.g., image 810, 820, 830, 840) including the crucible 112, electrode 102, and annular region 800 are captured by one or more cameras (e.g., camera 650, 652, 654). The neural network is applied to the images to determine the region of interest 812, 822, 832, 842. If more than one region of interest is selected, the selected region of interest 812, 822, 832, 842 will be the one with the highest confidence score. In one form, the region of interest 812, 822, 832, 842 includes a depiction of the annular region 800 that has the greatest distance between the electrode 102 and the ingot 104. The region of interest 812, 822, 832, 84 may include a depiction of other areas of the annular region 800, so long as the selection of the region of interest 812, 822, 832, 84 is consistent between images.

In subprocess 1510, a thickness of the shelf 602 is approximated. The thickness may be represented as a percentage of the annular region 800 or another geometry, quantity of pixels, an area (e.g., pixels squared, meters squared), or a physical distance (e.g., inches, millimeters). The thickness may be approximated with one or more of the steps described with regard to FIG. 16.

In step 1512, a system (e.g., VAR system 100) is operated. The system is operated based on the approximated thickness of the shelf 602. For example, an operating parameter (e.g., current, voltage, pressure, coolant flow, coolant temperature, field strength, electrode position, weight approximation, gap height) may be adjusted based on the approximated thickness of the shelf 602. The operation of the system 100 may include melting another portion of the electrode 102. For example, the approximation of the thickness of the shelf 602 may be used as an independent variable in the calculation or determination of another operating parameter. The approximation of the thickness of the shelf 602 may be used to augment a current voltage, pressure coolant flow, coolant temperature, field strength, electrode position, weight approximation, gap height, or another operating parameter to reduce the shelf thickness while the electrode 102 continues to be melted.

For example, the gap 606 between the electrode 102 and the molten pool 103 may be reduced or increased to reduce the shelf thickness. The gap 606 may be an average distance between the electrode 102 and the molten pool 103 as the molten pool 103 may have a slight parabolic or paraboloidal form when viewed perpendicular to a field of view of the camera 654. The gap 606 may be reduced by a step change, ramp change, or otherwise based on the approximation of the thickness of the shelf 602. For example, a typical gap 606 may be five millimeters, which may be reduced or increased in proportion to the approximation of the thickness of the shelf 602. The gap 606 may be step changed based on a predetermined quantity (e.g., one millimeter change in the gap for a approximated shelf thickness greater than a threshold).

The gap 606 may be approximated. For example, the actual gap 606 may be unknown and approximated using a vertical position of the electrode 102 (e.g., using a stepper or encoder), a weight of the ingot 104, or a combination thereof. The weight of the ingot 104 may include a weight associated with the molten pool 103. The gap 606 may be adjusted by a motor (e.g., stepper motor) configured to translate the electrode 102 through the crucible 112. For example, the motor may be attached to a linear actuator to adjust a height of the electrode 102 with respect to the ingot 104, molten pool 103, or crucible 112 at a particular rate (e.g., millimeters/minute, inches/minute). The rate of translation of the electrode 102 may be adjusted to adjust the gap 606 over time.

The adjustments described herein may be used during the remelting of various materials (e.g., nickel alloys, titanium alloys, and steels). The gap 606 may be provisioned specifically for a type of alloy. For example, the gap 606 may be one set point for a nickel alloy and another set point for a titanium alloy. Further, furnaces may have different construction or factors that require further adjustment of the gap 606 or other operating parameters. As such, an adjustment factor may be used to offset or otherwise adjust any of the operating parameters described herein to compensate for different alloys or furnaces. Further, the shelf thickness may be converted from a percentage to an actual distance to compensate for irregularities in the crucible 112 or electrode 102 (e.g., varying radii along a length of the electrode 102, ellipsoid deformations). The shelf 602 may have a thickness that is a linear dimension (e.g., distance from crucible) that is acted upon when the linear dimension is greater than a predetermined amount.

Step 1512 includes an adjustment to the electric current through one or more electromagnetic energy source 120′, 202. The electric current may be adjusted based on the thickness of the shelf 602. For example, the electric current may be reduced or increased. The electric current may be one or more of current waveform 502, 504, 512, 514, 522, 524. The electric current may be through one or more of the segments 310, 312, 320, 322, 330, 332, 350, 352, 360, 362, 370, 372, 434, 436. For example, the electric current produces a magnetic field that controls the motion of the arc in arc region 105 based on the thickness of the shelf 602. For example, as the thickness of the shelf 602 increases, the electric current may be increased to control the arc region 105, reducing the debris or accumulation thereof, on the crucible 112. In step 1514, the electrode 102 may be further melted and an image (e.g., image 810, 820, 830, 840) from one or more camera 650, 652, 654 may be used to estimate the thickness of the shelf 602 resulting from the additional melting of the electrode 102.

The electric current provided to the one or more electromagnetic energy sources 120′, 202 may be adjusted to maintain a ratio between the percentage of the annular region 800 occupied by the shelf 602 and a measure indicative of the current through the one or more electromagnetic energy sources 120′, 202. For example, a current amplitude-to-percentage ratio (e.g., current amplitude of 10 to 10% occupancy) may be used. If the shelf occupies 37.5% of the annular region 800, a current amplitude of 37.5 may be used. As another example, a case statement may be used to adjust the current amplitude based on the occupancy (e.g., 11-20% occupancy equals a current amplitude of 20, 21-30% occupancy equals a current amplitude of 30). A root sum of squares value of the current may be used instead of peak current amplitude. The electric current may be adjusted for one or more segment (e.g., segment 310, 312, 320, 322, 330, 332, 350, 352, 360, 362, 370, 372) of the one or more electromagnetic energy sources 120′, 202.

Referring to FIG. 16, a subprocess 1510 is shown in accordance with one or more implementation of the present disclosure. The subprocess 1510 provides steps that may be used to approximate the thickness of the shelf 602. Any of the steps of subprocess 1510 may be omitted, rearranged, or duplicated. For example, in step 1602, the region of interest (e.g., region of interest 812, 822, 832, 842) is converted from color to greyscale. The conversion to greyscale may remove color saturation (e.g., hue) from each pixel of the pixel data. In another step 1604, denoising or enhancements may be applied to the entire region of interest to increase the expression of edges. For example, Gaussian filter 1202 may be applied to denoise or enhance the region of interest (e.g., region of interest 812, 822, 832, 842). Strong edges (e.g., edges 902, 906) within the region of interest (e.g., region of interest 812, 822, 832, 842) may be determined with a thresholding algorithm that reduces the intra-class variance between pixels (e.g., removes greyscale to change the region of interest to black and white) in step 1606. The thresholding algorithm may be OTSU's ALGORITHM.

The edges 902, 906 may be determined in step 1608. For example, an edge detection algorithm may apply the Gaussian filter 1202 to the thresholded pixel data. Gradients over the image may be used to determine particular edges from each direction (e.g., horizontal, vertical). For example, a filter (e.g., filters 1204, 1206) may be used to determine each pixel of the edges 902, 906. The filters 1204, 1206 may be an edge detection operator or kernel. Spurious edges, or indications thereof, may be removed with suppression or thresholding. Additional thresholding may be used to remove spurious edges. For all gradients over a gradient threshold, the pixel may be marked as being associated with an edge. As an example, CANNY EDGE DETECTOR may be used to determine the pixels associated with edge 902 and the pixels associated with edge 906. Metadata may be updated to indicate which pixels are associated with each edge 902, 906.

In step 1610, edges associated with the shelf may be determined. For example, an edge detection algorithm may apply the Gaussian filter 1202 to the pixel data. The sigma value for the Gaussian filter 1202 applied to remove noise for the determination of the edges 904 of the shelf 602 may be different than the sigma value for the Gaussian filter 1202 used to remove noise for the determination of the edges 902, 906. For example, the sigma value for the Gaussian filter 1202 applied to remove noise for the determination of the edges 904 of the shelf 602 may be greater than the sigma value for the Gaussian filter 1202 used to remove noise for the determination of the edges 902, 906.

Gradients over the image may be used to determine particular edges from each direction. For example, a filter (e.g., filters 1204, 1206) may be used to determine a gradient for each pixel of the edges 902, 906 based on the surrounding pixels. The filters 1204, 1206 may be an edge detection operator or kernel (e.g., Roberts, Prewitt, Sobel). Spurious edges, or indications thereof, may be removed with suppression or thresholding. Additional thresholding may be used to remove spurious edges. For all gradients over a gradient threshold, the pixel may be marked as being associated with an edge. As an example, CANNY EDGE DETECTOR may be used to determine the pixels associated with edge. Metadata may be updated to indicate which pixels are associated with the edge 904. The edges 902, 904, 906 may be continuous or discontinuous over their length. For example, a discontinuous edge 904 is shown in FIGS. 9B-9D. After the edges 902, 904, 906, additional filtering may be used to properly express the edges. For example, the edges 902, 904, 906 may be smoothed with median filtering (e.g., replacing the color information of a given pixel with the median of the surrounding pixels). It should be appreciated that median filtering may be applied before or after any of the steps of subprocess 1510.

In step 1612, the image 810, 820, 830, 840 or region of interest 812, 822, 832, 842 may be checked to determine whether edges can be detected. For example, the image 810, 820, 830, 840 may be checked to determine whether all of the pixels are too bright or too dark, preventing the edges 902, 904, 906 from being determined or introducing too much noise for the edges 902, 904, 906 to have value. If the brightness of the image 810 is too high or too low, the process may stop and wait for the next image (e.g., image 820). The electric current through the one or more electromagnetic energy source may be maintained until the next image (e.g., image 820) is received and processed.

In step 1614, the thickness of shelf 602 is approximated. The thickness may be represented as a percentage of the annular region 800 or another geometry, quantity of pixels, an area (e.g., pixels squared, meters squared), or a physical distance (e.g., inches, millimeters). The approximate thickness of the shelf 602 may be based on one or more distances between pixels of the region of interest (e.g., region of interest 812, 822, 832, 842). For example, the distance between each pixel of the edge 904 may be determined with respect to either the edge 902 associated with the crucible 112 or the edge 906 associated with the electrode 102.

For a vertically-oriented region of interest where edge 902 is above or below edge 904, as shown in FIGS. 9A-9D, iterations over columns may be used. For a horizontally oriented region of interest where edge 902 is to the left or right of edge 904, iterations over rows may be used.

For example, in scanning columns for a vertically-oriented region of interest, the direction of arrow 1140 of FIG. 11 is used to iterate over each column (e.g., column 1136) by selecting the representative pixel (e.g., pixel 1104) for edge 904 that is closest to edge 902.

That is, the detection of edge 904 may result in multiple pixels (e.g., pixels 1104, 1134) being detected for a specific column (e.g., column 1136) because of the nature of greyscale pixel values used for determining the edge 904. For example, if a gradient threshold (e.g., gradients greater than a value) is used to determine all of the edges within the annular region 800, multiple pixels may be identified as relating to an edge for a column.

In such a circumstance, one of the pixels (e.g., one of pixels 1104, 1134) may be selected as representative for the column. Pixel data for each pixel (e.g., pixel 1104, 1134) of edge 904 being associated with a gradient greater than a value (e.g., gradient threshold) is added to a list for each column (e.g., pixel 1104, 1134 for the column 1136 as shown in FIG. 11). The pixel closest to edge 902 may be selected as representative of the column (e.g., pixel 1104), which is the pixel with the maximum height for a vertically-oriented regions of interest where the edge 902 is above edge 904. As another example, the pixel farthest from edge 902 may be selected as representative of the column (e.g., pixel 1134), which is the pixel with the minimum height for a vertically-oriented region of interest where the edge 902 is above edge 904. The process is repeated until a pixel distance is determined for each column across the region of interest 822 (e.g., distance 1108 for pixels 1102, 1104, distance 1128 for pixels 1122, 1124).

The average (e.g., mean, median) of the pixel distances between the edge 904 and one of the other edges 902, 906 may be used to determine the overall percentage of the annular region 800 occupied by the shelf 602. For example, the mean distance between edge 904 and edge 902 is 4.5 pixels and the mean quantity of pixels forming the annular region (e.g., distance between edge 902 and edge 906) is twelve pixels, indicating that the shelf 602 occupies a percentage of 37.5% of the annular region 800 with regard to this portion of the region of interest 822 at the time that image 820 was taken. Although described with respect to vertical distances, horizontal distances or radial distances (e.g., based on the Pythagorean theorem) may be used.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled engineer or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for forming an ingot from an electrode with a system, the system comprising a crucible and one or more electromagnetic energy sources, the method comprising:
melting a first portion of the electrode to form a molten pool within the crucible, wherein debris from the first portion of the electrode accumulates on an inner periphery of the crucible and accumulation of the debris forms a shelf;
approximating a thickness of the shelf; and
operating the system, wherein the operating of the system is based on the approximating the thickness of the shelf to control shelf thickness during the melting.

2. The method of claim 1, wherein the operating of the system comprises melting the electrode based on the approximation of the thickness of the shelf.

3. The method of claim 1, wherein the operating of the system comprises adjusting a gap between the electrode and the molten pool, wherein the adjustment of the gap is based on the thickness of the shelf.

4. The method of claim 3, wherein the gap is based on a weight of the ingot and a vertical position of the electrode.

5. The method of claim 1, wherein the operating of the system comprises adjusting electric current through the one or more electromagnetic energy source, wherein the adjustment of the electric current is based on the approximation of the thickness.

6. The method of claim 5, wherein the adjusting of electric current increases a root sum of squares value of the electric current over time.

7. The method of claim 1, wherein the approximation of the thickness is based on steps comprising:
selecting a region of interest, wherein the region of interest is based on an image and the region of interest comprises a depiction of an annular region between the electrode and the crucible;
identifying first data based on the region of interest, wherein the first data is indicative of a first edge;
identifying second data based on the region of interest, wherein the second data is indictive of a second edge; and
determining a distance based on the first data and the second data.

8. The method of claim 7, wherein the distance is indicative of the thickness of the shelf as a percentage of the annular region between the electrode and the crucible occupied by the shelf.

9. The method of claim 7, wherein the region of interest comprises pixel data and wherein the distance is based on a quantity of one or more pixels between a first pixel of the first data and a second pixel of the second data.

10. The method of claim 9, wherein the distance is based on a column of pixels or a row of pixels.

11. The method of claim 9, wherein the distance is a radial distance.

12. The method of claim 7, wherein the region of interest comprises pixel data and wherein the identifying of the first data is based on steps comprising removing hue information from the pixel data.

13. The method of claim 7, wherein the region of interest comprises pixel data and wherein the identifying of the first data is based on steps comprising applying a filter to the pixel data.

14. The method of claim 7, wherein the first edge is defined by an outer periphery of the electrode or the inner periphery of the crucible.

15. The method of claim 7, wherein the second edge is defined by one or more of the debris.

16. The method of claim 7, wherein the first data comprises a first pixel within the region of interest and the second data comprises a second pixel within the region of interest, and wherein the distance is based on a quantity of pixels between the first pixel and the second pixel.

17. The method of claim 7, wherein the selecting of the region of interest is based on a neural network, and the neural network comprises weights trained to recognize the region of interest based on a corpus of training images.

18. The method of claim 17, wherein the corpus of training images comprises depictions of annular regions similar to the annular region.

19. The method of claim 7, wherein the system comprises a camera and the method further comprises:
capturing the image with the camera; and
sending the image to a network video recorder.

20. A vacuum arc remelting (VAR) system for forming an ingot from an electrode, the VAR system comprising:
a crucible configured to accommodate the electrode and the ingot;
one or more electromagnetic energy sources arranged about the crucible; and
a controller configured to:
provide electric current to the one or more electromagnetic energy sources, and
adjust the electric current through the one or more electromagnetic energy sources, wherein the adjustment of the electric current is based on an approximation of a thickness of a shelf, wherein the shelf is formed based on an accumulation of debris on an inner periphery of the crucible.

21. The VAR system of claim 20, wherein the controller comprises:
one or more processor; and
one or more non-transitory computer-readable medium, wherein the one or more non-transitory computer-readable medium comprising instructions executable by the one or more processor cause the controller to:
provide the electric current, and
adjust the electric current through the one or more electromagnetic energy sources.

22. The VAR system of claim 20, wherein the one or more electromagnetic energy sources comprises a first electromagnetic energy source and a second electromagnetic energy source.

23. The VAR system of claim 20, wherein the one or more electromagnetic energy sources and the crucible are configured to move relative to one another along a longitudinal axis of the crucible.
